(19) United States
(12) Patent Application Publication
(10) Pub. No.: US 2024/0093709 A1
(43) Pub. Date: Mar. 21, 2024

(54) MECHANICAL LOCKING SYSTEM FOR BUILDING PANELS

(71) Applicant: Välinge Innovation AB, Viken (SE)

(72) Inventors: Niclas HÅKANSSON, Viken (SE); Darko PERVAN, Viken (SE)

(73) Assignee: Välinge Innovation AB, Viken (SE)

(21) Appl. No.: 18/239,924

(22) Filed: Aug. 30, 2023

Related U.S. Application Data
(63) Continuation of application No. 17/869,911, filed on Jul. 21, 2022, now Pat. No. 11,781,577.
Application No. 17/869,911 is a continuation of application No. 16/951,394, filed on Nov. 18, 2020, now Pat. No. 11,428,253.
Application No. 16/951,394 is a continuation of application No. 16/228,975, filed on Dec. 21, 2018, now Pat. No. 10,871,179.
Application No. 16/228,975 is a continuation of application No. 15/379,791, filed on Dec. 15, 2016, now Pat. No. 10,202,996.
Application No. 15/379,791 is a continuation of application No. 14/515,988, filed on Oct. 16, 2014, now Pat. No. 9,538,842.
Application No. 14/515,988 is a continuation of application No. 13/464,512, filed on May 4, 2012, now Pat. No. 8,887,468.
(60) Provisional application No. 61/483,444, filed on May 6, 2011.

(51) Int. Cl. F16B 12/12; A47B 47/00; A47B 47/04; F16B 5/00; F16B 12/26

(52) U.S. Cl. CPC F16B 12/125; A47B 47/0066; A47B 47/0075; A47B 47/042; F16B 5/0056; F16B 12/26; E04F 2201/0146; E04F 2201/0523; E04F 2201/0535; F16B 2200/67

(57) ABSTRACT

Panels are shown which are provided with a mechanical locking system allowing perpendicular connection with a snap action. A set of panels including a first and a second panel, an edge of the second panel is insertable into a groove of the first panel, when the panels are arranged essential perpendicular to each other, to obtain a mechanical connection between the first and the second panel, when the second panel is displaced essentially perpendicularly to the first panel.

### CROSS REFERENCE TO RELATED APPLICATIONS

The present application is a continuation of U.S. application Ser. No. 17/869,911, filed on Jul. 21, 2022, which is a continuation of U.S. application Ser. No. 16/951,394, filed on Nov. 18, 2020, now U.S. Pat. No. 11,428,253, which is a continuation of U.S. application Ser. No. 16/228,975, filed on Dec. 21, 2018, now U.S. Pat. No. 10,871,179, which is a continuation of U.S. application Ser. No. 15/379,791, filed on Dec. 15, 2016, now U.S. Pat. No. 10,202,996, which is a continuation of U.S. application Ser. No. 14/515,988, filed on Oct. 16, 2014, now U.S. Pat. No. 9,538,842, which is a continuation of U.S. application Ser. No. 13/464,512, filed on May 4, 2012, now U.S. Pat. No. 8,887,468, which claims the benefit of U.S. Provisional Application No. 61/483,444, filed on May 6, 2011. The entire contents of each of U.S. application Ser. No. 17/869,911, U.S. application Ser. No. 16/951,394, U.S. application Ser. No. 16/228,975, U.S. application Ser. No. 15/379,791, U.S. U.S. application Ser. No. 14/515,988, application Ser. No. 13/464,512, U.S. Provisional Application No. 61/483,444 and Swedish Application No. 1150400-8 are hereby incorporated herein by reference.

### TECHNICAL FIELD

The disclosure relates to the field of mechanical locking systems for building panels, especially furniture components with mechanical locking systems, which are intended to lock preferably perpendicular to each other.

### FIELD OF APPLICATION OF EMBODIMENTS

Embodiments of the present invention are particularly suitable for use in furniture components, which are preferably formed of sheet shaped panels, and which are joined mechanically with a locking system integrated with the panel, i.e. mounted at the factory. The following description of known technology, problems of known systems and objects and features of the invention will therefore, as a non-restrictive example, be aimed above all at this field of application and in particular at furniture components formed as rectangular panels intended to be mechanically joined on one pair of opposite edges perpendicularly to other adjacent panels. The panels may also be square.

It should be emphasized that the invention can be applied to any type of sheet shaped panel such as for example wood based HDF, particle board and plywood, plastic sheet shaped materials, mineral fibre and metal based materials, stone, and ceramics and similar. It may be used to connect furniture components, and elements for packaging boxes and similar. It may also be used to lock components, which for example have a cylinder form such as table legs.

### BACKGROUND

Furniture such as kitchen cabinets, bookshelves, drawers, tables and similar are generally supplied as flat components in order to save transportation costs. The customer must assemble them. Several methods are used to assemble such furniture components, for example, glue, spikes, screws and similar. Snapping connections comprising plastic components are widely used to connect, for example, drawers.

### Known Technology and Problems Thereof

There are a lot of problems connected with the assembly of furniture components especially when one panel should be connected perpendicularly to another panel. Generally special connection devices are supplied that have to be inserted into grooves and holes. Such assembly is complicated and time consuming and the connection is often not strong enough. Snapping connections formed in plastic materials are expensive and complicated to produce. It would be an advantage if assembly may be simplified and if no loose parts would be needed in order to connect panels to each other in a firm, cost efficient and rigid manner.

WO 2010/070472 describes locking systems that may be used to assemble furniture components with angling and snapping. The locking systems may be formed in one piece with the panel or, alternatively, a separate plastic tongue with an outer flexible snap tab may be used. Such locking systems do not give sufficient strength and rigidity especially when rather soft core materials, such as particleboard, are used. The locking system is complicated to produce since the flexible tongue cannot be connected to the components with a linear displacement into a groove. The outer flexible part is generally not strong enough to provide a rigid connection.

### SUMMARY

A basic objective of embodiments of the present invention is to provide an improved mechanical locking system which may be produced in a cost effective way, and which allows preferably rectangular panels to be connected and assembled mechanically perpendicularly to each other with a strong locking and in a simple manner without the need for loose parts that has to be used during assembly.

The above objects of embodiments of the invention are achieved wholly or partly by mechanical locking systems and panels, according to the independent claim that provide a stronger and easier locking. Embodiments of the invention are evident from the dependent claims and from the description and drawings.

A first aspect of the invention is a set of panels comprising a first and a second panel. An edge of the second panel is insertable into a groove of the first panel, when the panels are arranged essential perpendicular to each other, to obtain a mechanical connection between the first and the second panel, when the second panel is displaced essentially perpendicularly to the first panel. The edge comprises a separate and flexible tongue and said groove comprises a tongue groove, or said edge comprises a tongue groove and said groove comprises a separate and flexible tongue. The separate and flexible tongue is insertable into the tongue groove for connecting said panels to each other in a first direction, which is parallel to a main plane of the first panel. The edge of the second panel is configured to cooperate with the groove of the first panel for connecting said panels to each other in a second direction, which is parallel to a main plane (MP) of the second panel. The length direction of the separate and flexible tongue extends parallel with said edge and/or groove. The groove preferably comprises an opening, two sidewalls and a bottom. The separate and flexible tongue is arranged in an insertion groove. The separate and flexible tongue has an inner part mounted in the insertion groove and an outer part extending outside an opening of the insertion groove. A part of the separate tongue is displaced in the insertion groove during locking. The flexible tongue is preferably displaceable inwardly towards a bottom of the insertion groove and outwardly into the tongue groove during locking.

The tongue may comprise two opposite displacement surfaces located between the inner and outer parts of the separate and flexible tongue. One or both of said two opposite displacement surfaces may be displaceable against a wall(s) of the insertion groove during locking.

A locking involving displacement of a displacement surface against an upper or lower wall of the insertion groove may make it possible use a tongue with a rigid outer part. That may facilitate a strong locking even in rather soft materials such a particle boards that are often used a base material in furniture components. The outer rigid part may be displaced into a rather deep tongue groove and a firm locking may be obtained.

Said insertion groove may be inclined upwards with the opening closer to the main plane of the panel than the inner part of the insertion groove. Such inclination may facilitate the insertion of the separate tongue into the insertion groove during production since the tongue may be inserted with a linear motion into the displacement groove.

The separate and flexible tongue may, when the edge of the second panel is inserted into the groove of the first panel, lock by snapping.

The inner part may be fixed in the insertion groove by e.g. friction connection or by glue.

The inner part of the tongue may comprise one or several flexible protrusions extending in the length direction of the tongue.

The first and/or the second panel may comprise separate materials that form an edge or a groove portion. A particleboard panel may be reinforced with solid wood, plywood, HDF and similar wood based materials that are glued or mechanically connected to the panels in order to form at least a part of the locking system.

The second panel may have an outer edge with a smaller thickness than the thickness of the panel body such that the panel body overlaps one or both parts of the groove opening when the second panel is inserted into the groove of the first panel.

At least a part of the tongue and/or the groove may be formed in the first and the second panel respectively before a part of the tongue and/or the groove, and preferably a part of the panel, may be covered by a layer, such as a foil.

The above-described locking system allows that panels may be locked automatically perpendicularly to each other with a snap action and without any loose parts. The flexible tongue provides a strong and easy locking in middle sections and in corner sections.

The tongue is preferably factory connected but it may of course be delivered separately in blanks or as a separate loose component and inserted into a groove during installation.

The panels may not be only connectable perpendicular to each other but may also be connectable to each other at an angle of less than 180° between the main planes of the first and the second panel or preferably in the range of about 45° to about 135°.

### BRIEF DESCRIPTION OF THE DRAWINGS

FIGS. 1a-1c illustrate a perpendicular snap action of a middle section according to an embodiment of the invention.

FIGS. 2a-2b illustrate a corner section according to an embodiment of the invention.

FIGS. 2c-2d illustrate corner section or middle sections according to embodiments of the invention.

FIGS. 3a-3b illustrate locking of four panels and a corner section according to embodiments of the invention.

FIGS. 4a-4d illustrate a bristle tongue and a bow shaped tongue according to embodiments of the invention.

FIGS. 5a-5c illustrate embodiments of the invention.

FIGS. 6a-6c illustrate embodiments of the invention.

FIGS. 7a-7c illustrate embodiments of the invention.

FIGS. 8a-8b illustrate an angling connection according to embodiments of the invention.

FIGS. 9a-9d illustrate a partial groove and a side push tongue according to embodiments of the invention.

FIGS. 10a-10c illustrate embodiments of the invention.

FIGS. 11a-11d illustrate embodiments of the invention in a 3d view.

### DESCRIPTION OF EMBODIMENTS

To facilitate understanding, several locking systems in the figures are shown schematically. It should be emphasized that improved or different functions can be achieved using combinations of the preferred embodiments.

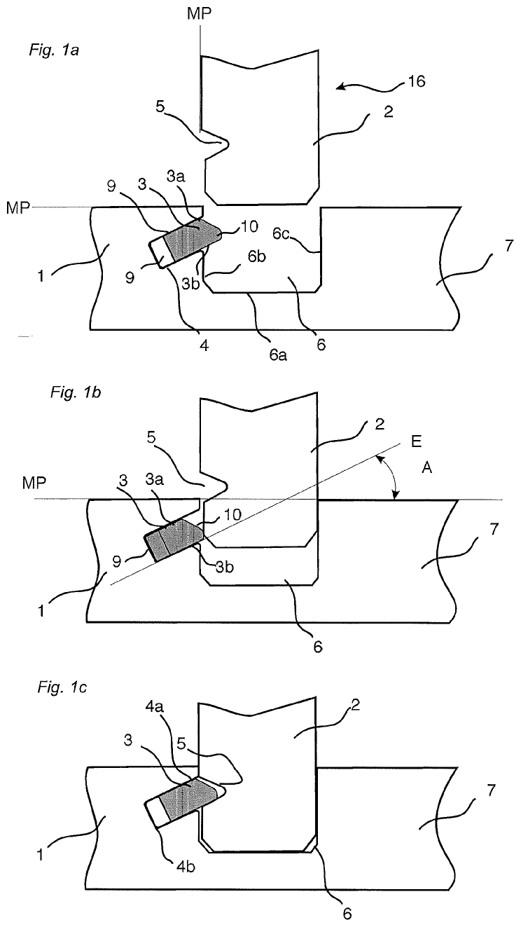

FIGS. 1a-1c show a connection with a perpendicular snap action according to a preferred embodiment of the invention. FIG. 1a shows a first 1 and a second 2 panel. The first panel 1 comprises a groove 6, formed in the panel core 7. The groove comprises a bottom 6a and two opposite groove walls 6b, 6c. The groove is open towards a main plane MP of the first panel 1. An insertion groove 4 is formed in one of the groove walls 6b. The insertion groove 4 is preferably inclined in relation to the main plane MP of the panel such that the opening of the insertion groove 4a is closer to the main plane MP than the inner part 4b. It is preferred that a linear extension E of the insertion groove extends at or more preferably above the opening of the groove 6. This makes it possible to form the insertion groove with large rotating tools and to insert a separate tongue 3 into the groove. The insertion groove is preferably inclined with an angle A of about 10-45 degrees. The insertion groove comprises a flexible tongue 3, which has an inner part 9 and an outer part 10 and preferably two opposite sliding surfaces 3a and 3b between the inner 9 and the outer 10 parts.

FIG. 1b shows how the flexible tongue 3 with its displacement surfaces 3a, 3b is displaced inwardly into the insertion groove 4 when the second panel 2 is inserted into the groove 6 perpendicularly to the first panel 1.

FIG. 1c shows how the flexible tongue 3 is displaced in the insertion groove outwardly into the tongue groove 5 such that the second panel is connected perpendicular and parallel to the first panel with preferably a snap action. The flexible tongue and the tongue groove lock the panels perpendicularly to the main plane MP of the first panel 1. The groove 6 and the edge 16 of the second panel lock the panels parallel to the main plane MP of the first panel 1. The flexible tongue 3 may be locked with pre tension into the tongue groove 5.

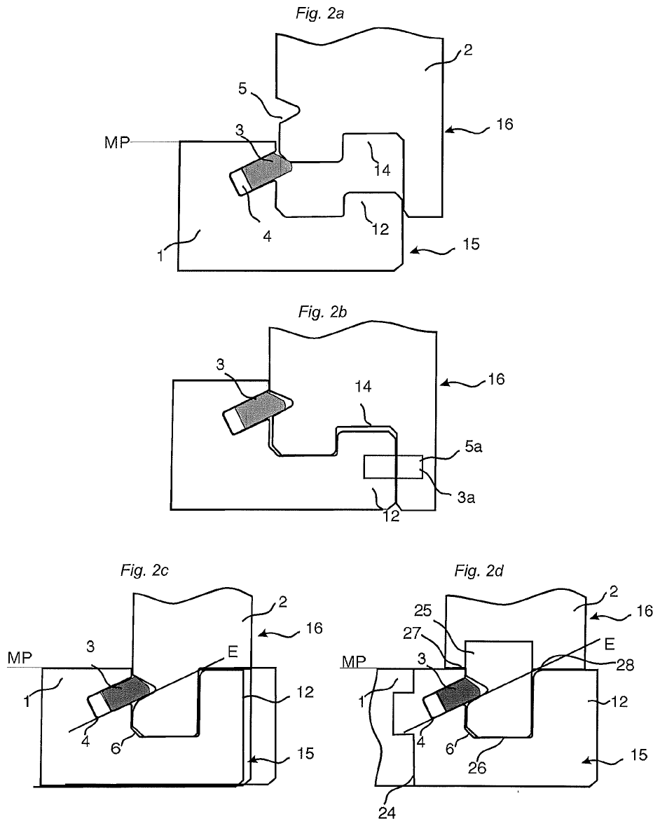

FIGS. 2a and 2b show another preferred embodiment of the invention where the edge 15, of the first panel comprises a locking element 12 and the edge 16 of the second panel comprises a locking groove 14. The locking element and the locking groove locks the panels parallel to the main plane of the first panel. This embodiment may be used to connect corner sections. A tongue and a tongue groove 5a may also be located and formed on the outer part of the locking element 12 and/or in a groove wall of the locking groove 14 as shown in FIG. 2b. There may be a space between the outer part of the locking element 12 and the locking groove, or a play or a tight fit. The insertion groove 4 may be formed in the second panel and the tongue groove 5 in the first panel. The insertion groove and/or the locking surfaces between the flexible tongue and the tongue groove may be inclined or essentially parallel to the main plane MP of the first panel.

FIG. 2c shows an alternative embodiment, which may be used to connect corner sections or middle sections. The edge 15, of the first panel 1, comprises a locking element 12 that in locked position forms an outer free end of the panel. The flexible tongue 3 is displaced inwardly into the insertion groove 4 when the second panel 2 is inserted into the groove 6 perpendicularly to the first panel 1. The inclination of the insertion groove 4 facilitates the insertion of the flexible tongue 3 into the insertion groove 4 during production and locking may be accomplished with lower resistance since the flexible tongue 3 slides inwardly and downwardly during locking. The insertion groove is preferably inclined such that an extension E of its lower part is located at or above the upper part of the locking element 12.

FIG. 2d shows that the second panel 2 may have an outer edge 26 with a smaller thickness than the panel body 2 such that the panel body 2 overlaps one 27 or both parts 27, 28 of the groove opening when the second panel 2 is inserted into the groove 6 of the first panel 1. The first and/or the second panel may comprise separate materials 24, 25 that form an edge or a groove portion of the first or the second panels. A particle board panel may for example be reinforced with solid wood, plywood, HDF and similar wood based materials that are glued or mechanically connected to the panel in order to form at least a part of the locking system. Separate materials may be covered with for example a foil, paper or paint.

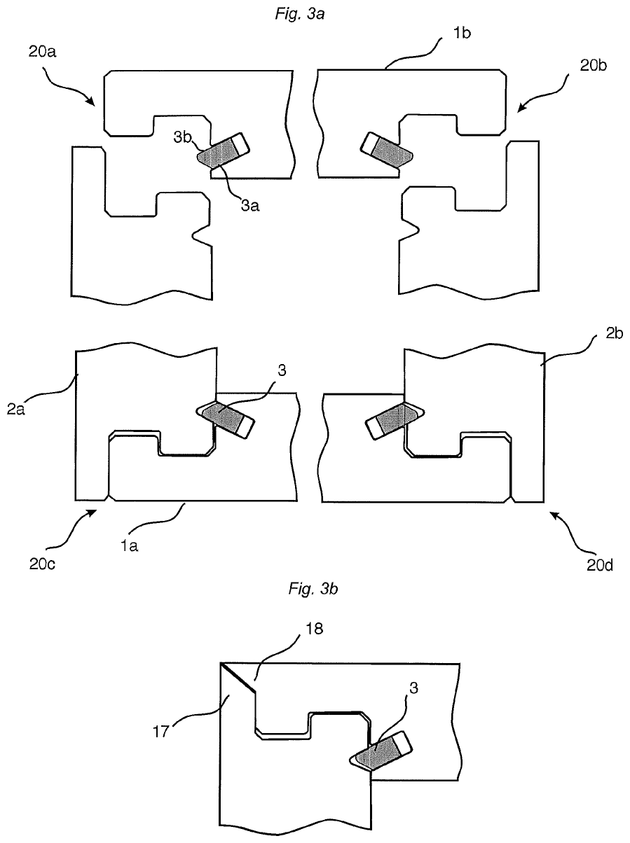

FIG. 3a shows a connection of four corner sections 20a, b, c, d. Four panels of for example a kitchen cabinet may be connected. A first panel 1a is placed on a floor. A second 2a and a third 2b panel are connected with snapping to the first panel 1a. Finally a fourth panel 1b is connected to the second and third panels.

FIG. 3b shows a corner section where the adjacent panel edges 17, 18 are inclined, preferably inwardly and preferably with an angle of about 45 degrees against the main plane of the panels.

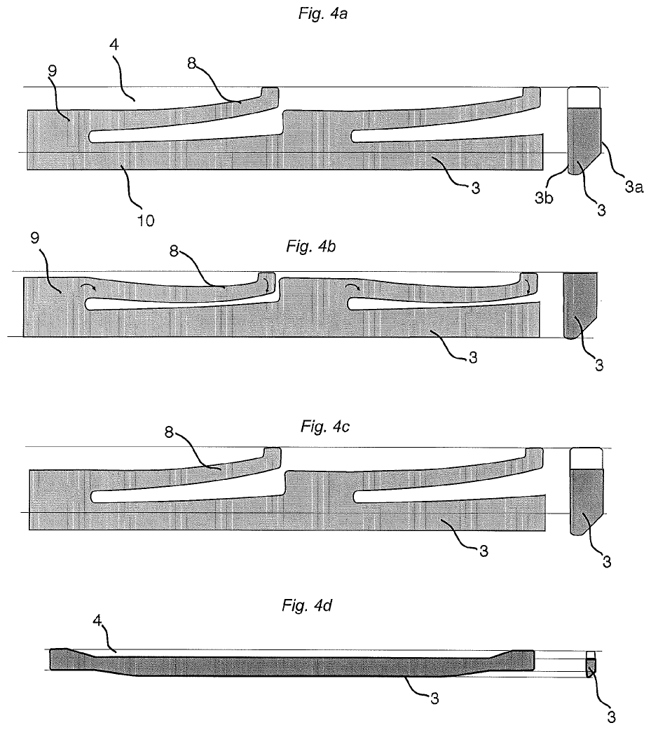

FIGS. 4a-4c show a known flexible bristle tongue 3, which is used to connect floor panels. Such a tongue may be used to connect panels according to embodiments of the invention. The tongue comprises flexible protrusions 8 that bend in the length direction of the tongue and that displace the tongue in the insertion groove during the snap action. FIG. 4a shows the tongue in the outer position prior to locking, FIG. 4b shows the tongue 3 in the inner position during locking, and FIG. 4c shows the tongue 3 in the outer and locked position.

FIG. 4d shows a flexible bow shaped tongue 3 that bends in the length direction.

All known flexible tongues that are used to lock floor panels may be used in embodiments of this invention. Tongues that bend in the length direction are preferred, for example, bristle tongues and bow shaped tongues, as shown in FIGS. 4a and 4d, since such tongues have the advantage that flexibility may be combined with a rigid and strong outer part that creates a strong locking even in rather soft core materials such as particle boards that are generally used as a core in furniture components. It is an advantage if the tongue creates a pre tension against the tongue groove in locked position. This gives a stronger locking and eliminates production tolerances especially if the locking surface of the tongue/tongue groove is inclined against the main plane of the first panel. The tongue is preferably formed of an injection moulded plastic material preferably reinforced with glass fibres.

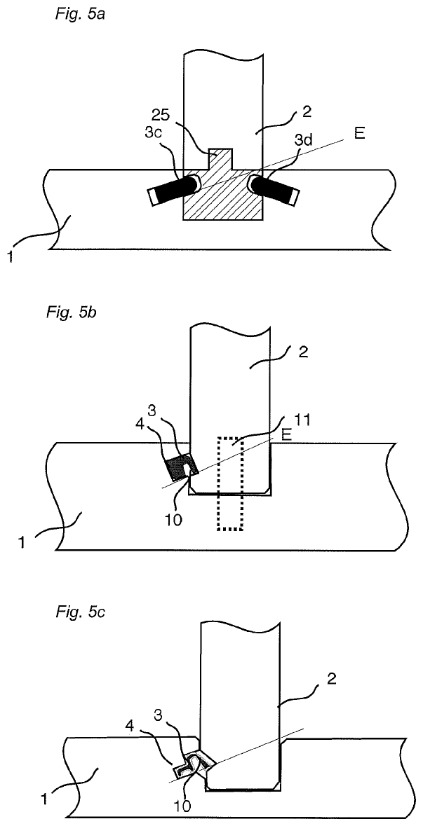

FIG. 5a shows an embodiment with two tongues 3c, 3d. The edge of the second panel 2 may comprise a separate material 25.

FIG. 5b shows a tongue 3 that comprise an outer part 4 with a snap tab that during snapping is displaced at least partly into an inclined insertion groove 4. The locking system comprises a stabilizing tongue 11 that may be formed in one piece with the core or inserted as a separate element.

FIG. 5c shows a tongue 3 comprising a snap tab 10 that during snapping is displaced outside the insertion groove 4.

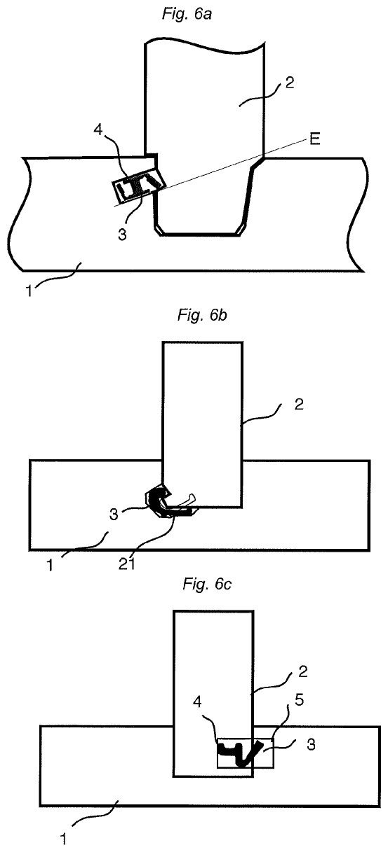

FIG. 6a shows a tongue that comprises an inner and outer flexible part. FIG. 6b shows an embodiment with a turning and snapping tongue 3 comprising a pressing arm 21 that turns and snaps the tongue 3 into a tongue groove.

FIG. 6c shows schematically that the insertion groove 4 may be formed in the second panel 2.

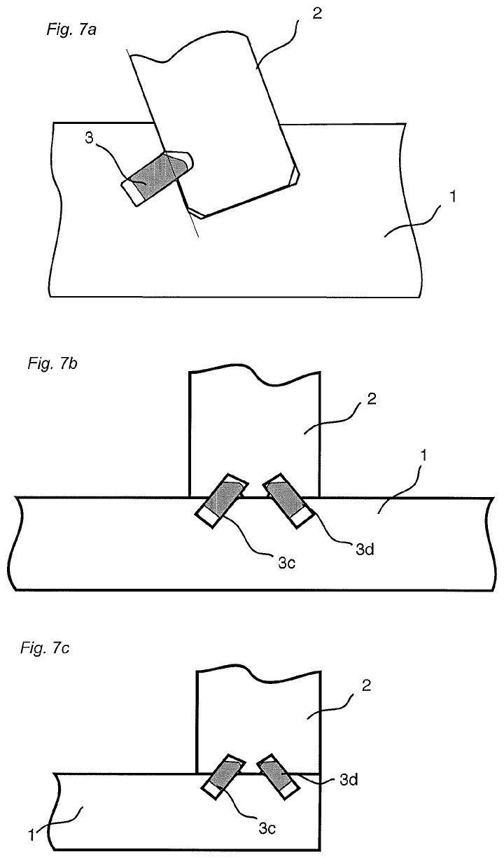

FIGS. 7a-7c show alternative positions of the flexible tongues. FIG. 7a shows that the second panel may be somewhat inclined for example 45-89 degrees against main plane of the first panel. FIG. 7b shows two tongues 3c, 3d attached to a middle section of a first panel 1 and FIG. 7c shows a corner section.

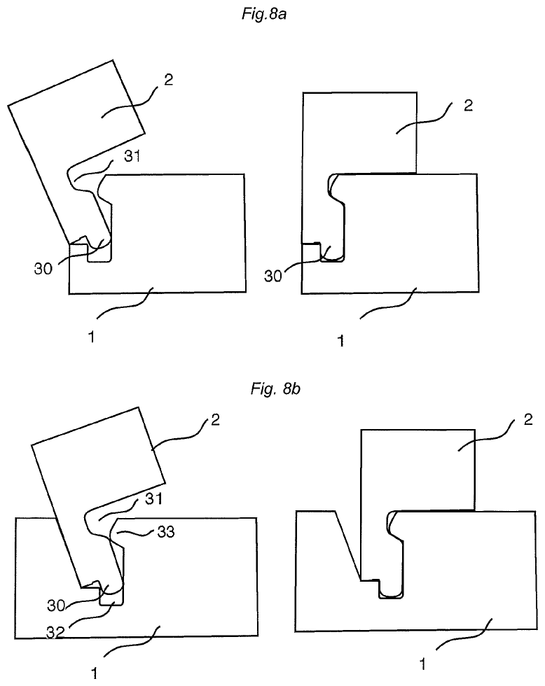

FIGS. 8a and 8b shows that two panels may be angled together according to the generally known principles used in locking systems for flooring. Such angling connection may be combined with all snapping embodiments described above. FIG. 8a shows an angling connection of a corner section and FIG. 8b shows an angling connection of a middle section. The second panel 2 that is angled during connection comprises a tongue and a locking groove 31 that cooperates during locking with a tongue groove 32 and a locking element 33 formed in the first panel.

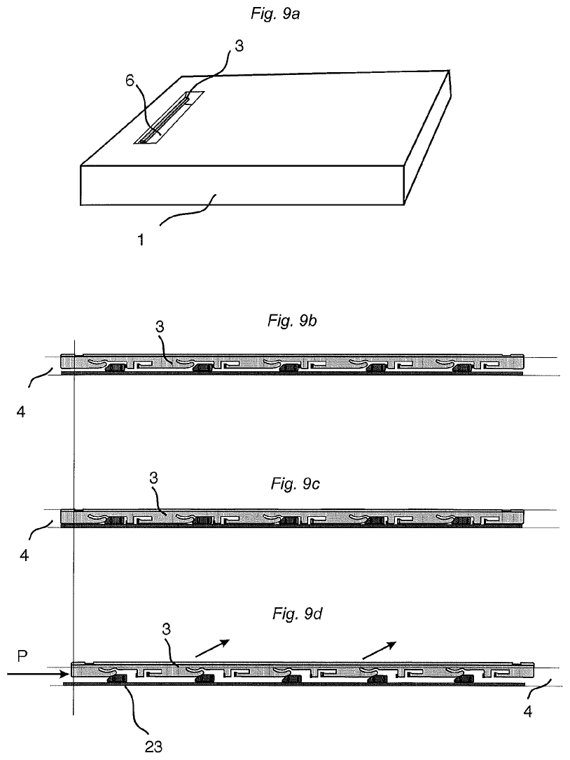

All fixation and tongue grooves may be formed over the complete length or with of a panel. They may also be formed as one or several local grooves, which only extend along a part of the panel. Such grooves may be formed in many ways for example with rotating jumping tool heads. Such a local groove 6 is schematically shown in FIG. 9a.

FIGS. 9b-9d show that the so-called side push locking systems may also be used to connect furniture components. Such a tongue 3 that is displaced width a side pressure P along the insertion groove 4 and perpendicularly to the insertion groove into the tongue groove may be used in all embodiments shown above. The perpendicular displacement may be accomplished with wedges 23 or with a fixation groove, which have a depth that varies along the groove. The tongue 3 and the tongue groove may also comprise overlapping protrusion and a locking may be accomplished with a displacement along the insertion groove without any perpendicular displacement into the tongue groove. Such embodiments allow locking with a rigid tongue and no flexible parts are needed.

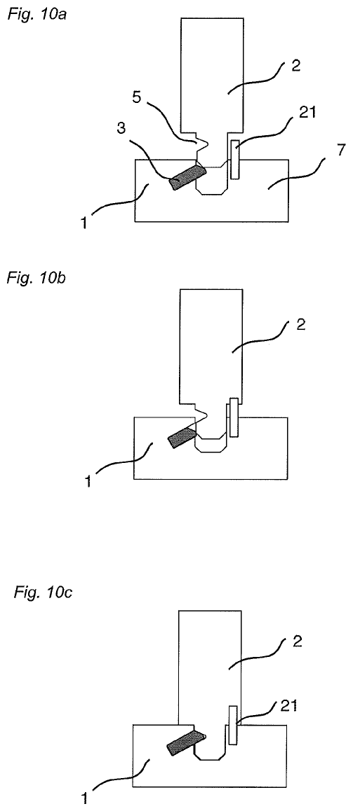

FIGS. 10a-10c show an embodiment of the invention further comprising a plug 21 of, e.g., plastic, wood or metal at of the panels 1, 2 inserted into a hole, preferably at the edge of the other panel. The plug and the hole increases the strength of the connection and may be used to position the panels.

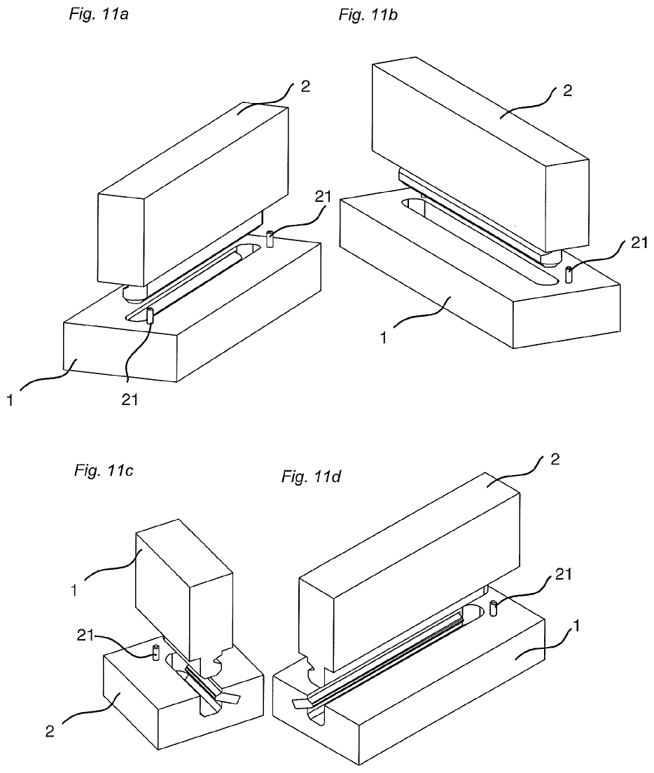

FIGS. 11a-11b show the embodiment in FIGS. 10a-10c in a 3d view at two different angles and FIGS. 11c-11d a cross section in a 3d view at two different angles.

### Embodiments

1. A set of panels (1,2) comprising a first (1) and a second panel (2), an edge (16) of the second panel is insertable into a groove (6) of the first panel (1), when the panels are arranged essential perpendicular to each other, to obtain a mechanical connection between the first and the second panel, when the second panel is displaced essentially perpendicularly to the first panel, wherein:
   said edge (16) comprises a separate and flexible tongue (3) and said groove (6) comprises a tongue groove (5), or said edge (16) comprises a tongue groove (5) and said groove (6) comprises a separate and flexible tongue (3);
   the separate and flexible tongue (3) is insertable into the tongue groove (5) for connecting said panels to each other in a first direction, which is parallel to a main plane (MP) of the first panel;
   the edge (16) of the second panel is configured to cooperate with the groove (6) of the first panel for connecting said panels to each other in a second direction, which is parallel to a main plane (MP) of the second panel;
   the length direction of the separate and flexible tongue (3) extends parallel with said edge and/or groove;
   the groove (6) comprises an opening, two side walls (6b, 6c) and a bottom (6a);
   the separate and flexible tongue (3) is arranged in an insertion groove (4);
   the separate and flexible tongue has an inner part (9) mounted in the insertion groove (4) and an outer part (10) extending outside an opening of the insertion groove; and
   the flexible tongue is displaceable inwardly towards a bottom of the insertion groove (4) and outwardly into the tongue groove (5) during locking.
2. The set of panels as recited in embodiment 1, wherein the flexible tongue has two opposite displacement surfaces (3a, 3b) located between the inner and the outer parts, each of the two opposite displacement surfaces of the flexible tongue (3) are displaceable against an upper and a lower wall respectively of the insertion groove during locking, inwardly towards the bottom of the insertion groove (4) and outwardly into the tongue groove (5).
3. The set of panels as recited in embodiment 1 or 2, wherein the said insertion groove (4) is inclined upwards with the opening closer to the main plane (MP) of the panel than the inner part insertion groove (4).
4. The set of panels as recited in any of the preceding embodiments, wherein the insertion groove (4) is inclined such that an extension E of its lower part is located at or above the upper part of the opening of the groove (6).
5. The set of panels as recited in any of the preceding embodiments, wherein the second panel comprises an outer edge with a smaller thickness than the panel body (2) such that the panel body overlaps one or both parts of the groove (6) opening (27, 28) when the second panel (2) is inserted into the groove (6) of the first panel (1).
6. The set of panels as recited in any of the preceding embodiments, wherein the inner part of the tongue (9) comprises one or several flexible protrusions (8) extending in the length direction of the tongue (3).
7. The set of panels as recited in any of the preceding embodiments, wherein the insertion groove (4) is formed in the groove (6) of the first panel (1).
8. The set of panels as recited in any of the preceding embodiments, wherein the insertion groove (4) is inclined in relation to the main plane of the second panel with an angle of about 10-45 degrees.
9. The set of panels as recited in any of the preceding embodiments, wherein the panels comprises at least two flexible tongues separated from each other.
10. The set of panels as recited in any of the preceding embodiments, wherein the groove (6) is formed as a partial groove extending along a part of a panel.
11. The set of panels as recited in any of the preceding embodiments, wherein the panels are provided with a locking element (12) and a locking groove (14) for locking the panels parallel to the main plane (MP) of the first panel (1).
12. The set of panels as recited in any of the preceding embodiments, wherein adjacent outer panel edges (17,18) in a corner portion are inclined inwardly against the main plane (MP) of the panels.
13. The set of panels as recited in any of the preceding embodiments, wherein the tongue (3) is locked with pre tension against the tongue groove (5).
14. The set of panels as recited in any of the preceding embodiments, wherein the resilient parts are formed of an injection moulded plastic material.
15. The set of panels as recited in any of the preceding embodiments, wherein the first and/or the second panel comprise separate materials (24, 25) that form an edge or a groove portion.
16. The set of panels as recited in embodiment 15, wherein the separate material is covered with a foil.

1. (canceled)

2. A set of furniture components provided with a mechanical locking system for locking a first panel and a second panel essentially perpendicularly to each other,
the mechanical locking system comprising:
a groove provided in the first panel,
an edge of the second panel,
an insertion groove provided in the groove of the first panel, a separate and flexible tongue being provided in the insertion groove, and
a tongue groove provided in the edge of the second panel,
wherein the edge of the second panel is configured to be inserted into the groove of the first panel for locking said first and second panels to each other in a direction perpendicular to the main plane of the second panel,
wherein the separate and flexible tongue is configured to cooperate with the tongue groove for locking said first and second panels to each other in a direction perpendicular to the main plane of the first panel,
wherein the insertion groove is inclined upwards, a distance from an opening of the insertion groove to the main plane of the first panel being smaller than a distance from an inner part of the insertion groove to the main plane of the first panel, and
wherein the groove comprises a tapering inner portion and/or wherein the edge comprises a tapering outer portion.

3. The set of furniture components according to claim 2, wherein the groove tapers down continuously in an inward direction of the groove.

4. The set of furniture components according to claim 2, wherein a bottom portion of the groove comprises a bevel.

5. The set of furniture components according to claim 2, wherein an outer portion of the groove comprises a bevel such that a width of the outer portion of the groove decreases in an inward direction of the groove.

6. The set of furniture components according to claim 2, wherein an outer portion of the edge comprises a bevel such that a width of the outer portion of the edge decreases in an outward direction of the edge.

7. The set of furniture components according to claim 2, wherein the edge tapers continuously.

8. The set of furniture components according to claim 2, wherein the edge tapers continuously along a length corresponding to a depth of the groove.

9. The set of furniture components according to claim 2, wherein the edge of the second panel is configured to be inserted into the groove of the first panel when the main planes of the first panel and the second panel are arranged essentially perpendicularly to each other.

10. The set of furniture components according to claim 2, wherein the insertion groove is formed in a side wall of the groove of the first panel.

11. The set of furniture components according to claim 2, wherein the insertion groove is inclined such that a linear extension of a lower part of the insertion groove is located at or above an upper part of the opening of the groove.

12. The set of furniture components according to claim 2, wherein a panel body of the second panel overlaps one or both parts of a groove opening when the edge of the second panel is inserted into the groove of the first panel.

13. The set of furniture components according to claim 2, wherein the main plane of the first panel is provided along a side surface of the first panel in which the groove is provided.

14. The set of furniture components according to claim 2, wherein the separate and flexible tongue comprises an outer flexible part.

15. The set of furniture components according to claim 2, wherein the separate and flexible tongue comprises an inner flexible part.

16. The set of furniture components according to claim 2, wherein an inner part of the separate and flexible tongue comprises one or several flexible protrusions extending in a length direction of the separate and flexible tongue.

17. The set of furniture components according to claim 2, wherein a length direction of the separate and flexible tongue extends along a length direction of the groove.

18. The set of furniture components according to claim 2, wherein an inner part of the separate and flexible tongue is provided in the insertion groove and wherein an outer part of the separate and flexible tongue extends outside of the insertion groove in a locked state of the first and second panels.

19. The set of furniture components according to claim 2, wherein the separate and flexible tongue is configured to be displaced inwardly towards a bottom of the insertion groove and outwardly into the tongue groove during locking.

20. The set of furniture components according to claim 2, wherein the separate and flexible tongue is configured to be linearly displaced in the insertion groove.

21. The set of furniture components according to claim 2, wherein the separate and flexible tongue has two opposite displacement surfaces configured to be displaced against an upper wall and a lower wall of the insertion groove during locking.
